(19) United States
(12) Patent Application Publication
(10) Pub. No.: US 2004/0224681 A1
(43) Pub. Date: Nov. 11, 2004

(54) Routed home network

(75) Inventor: Hans Sjostrand, Hagersten (SE)

Correspondence Address: BANNER & WITCOFF, 1001 G STREET N W, SUITE 1100, WASHINGTON, DC, 20001, US

(73) Assignee: Interactive People Unplugged AB, Stockholm (SE)

(21) Appl. No.: 10/786,225

(22) Filed: Feb. 26, 2004

Related U.S. Application Data
(60) Provisional application No. 60/449,839, filed on Feb. 27, 2003.

(51) Int. Cl. H04Q 7/20

(52) U.S. Cl. 455/433

(57) ABSTRACT

The present invention relates to a method for decoupling a Mobile IP home network from its Mobile IP Home Agent with support for roaming on the intranet as well as the Internet. The normal operation of the IGP is assumed, and a static route for a Mobile Address aggregate is used to distribute Mobile IP addresses in the IGP.

### FIELD OF INVENTION

The present invention relates to mobile data communication in general. More specifically, the present invention describes a technique to decouple the Mobile IP home network from the Mobile IP home agent. It describes how this could be achieved and what functionality is introduced to the different networks in order to achieve it.

### DESCRIPTION OF THE BACKGROUND ART

The following definitions are introduced for the purpose of clarity.

Mobile IP. Mobile IP is an IP mobility standard being defined by the IETF with the purpose to make IP networks mobility aware, i.e. providing IP entities knowledge on where a Mobile Node is attached to the network.

FA Foreign Agent: The primary responsibility of an FA is to act as a tunnel agent which establishes a tunnel to a HA on behalf of a Mobile Node in mobile IP.

HA Home Agent: The primary responsibility of the HA is to act as a tunnel agent which terminates the mobile IP tunnel, and which encapsulates datagrams to be sent to the Mobile Node in mobile IP.

IETF Internet Engineering Task Force: The IETF is the standardization organization for the Internet community.

Mobile Home Network: The network where you in a mobility sense are home. This also denotes the address space where your mobile home address is defined.

IP Internet Protocol. IP is a network layer protocol according to the ISO protocol layering. IP is the end-to-end protocol between Mobile and Fixed End-Systems for Data Communications.

Mobile Client: Referred to in the Mobile IP standard as the Mobile Node.

MN Mobile Node: comprises both the Terminal Equipment (TE) and the Mobile Termination (MT). Most often a laptop or PDA/smartphone with wireless interfaces and Mobile IP software.

RFC Request For Comment: The collective name of standard documents produced within the IETF. Each standard document starts with RFC and a number, e.g. RFC3344.

IGP Interior Gateway Protocol. Internet protocol used to exchange routing information within an autonomous system

OSPF Open Shortest Path First (OSPF) is a routing protocol developed for Internet Protocol (IP) networks by Internet Engineering Task Force (IETF). OSPF is an example of a IGP (Interior Gateway Protocol).

ARP ARP is a mechanism defined by IETF in RFC826 for converting Network Protocol Addresses (such as IP addresses) to Ethernet Addresses for transmission on Ethernets.

Proxy ARP A particular machine (such as a gateway) will respond to ARP requests for hosts other than itself.

Mobile IP is defining a Home Agent as the anchor point with which the Mobile Node always has a relationship, and a Foreign Agent, which acts as the local tunnel-endpoint at the access network where the Mobile Node is visiting. While moving from one IP sub network to another, the Mobile Node point of attachment (FA) may change. At each point of attachment, mobile IP either requires the availability of a standalone Foreign Agent or the usage of a co-located care-of address in the Mobile Node itself in the case that no Foreign Agent is available.

The Home Network in Mobile-IP is where the Mobile Client spends most of its time, where it has a secure and reliable network Connection and where most of its network resources and servers are located nearby.

In Mobile-IP, the home network of a Mobile Client is restricted to a single LAN segment. When the Mobile Client is away from home, packets destined to the Mobile Client are received by the Client's Home Agent, which is attached to the segment. The Home Agent then tunnels the packets to the Mobile Clients current location.

In Mobile-IP, the Home Agent must be attached to the Client's home LAN segment. However, there are practical limitations on the number of hosts attached to the same collision domain, and the geographical distribution of a LAN segment. Therefore, the number of Clients that are able to be at home (i.e., deregistered) in a Mobile-IP sense is limited for a single Home Agent entity (HA).

It's not feasible to have a HA for each of these small groups as this would require complete redesign of the intranet and add-up costs. It's also unfeasible to have fewer (or only one) HA's with users connecting up away co-located for most of the time, thus tromboning up all traffic to some central points.

The following references are also of general interest for the understanding of the present invention:

David C. Plummer, “An Ethernet Address Resolution Protocol”, RFC826;

http://www.ieff.org/rfc/rfc826.txt; November 1982

Moy, J., “OSPF Version 2”, RFC 2328,; http://www.ieff.org/rfc/rfc2328.txt; April 1998

Droms, R.; Dynamic Host Configuration Protocol; RFC2131; http://www.ieff.org/rfc/rfc2l31.txt; March 1997

Perkins, Charlie; IP Mobility Support; RFC3344; http://www.ieff.org/rfc/rfc3344.txt; August 2002.

### SUMMARY OF THE PRESENT INVENTION

Requirements

The present invention sets out to provide a solution to decouple the Mobile IP home network from the Mobile IP home agent according to the following requirements:

Changes to the HA and MN only

The Home Agent and should be amended with new functionality. The new features for the MN should be held to a minimum but are accepted.

Special configuration in the intranet pysical sub network hosting the virtual home network are acceptable. However, no special configuration to other intranet networks other than the one hosting the virtual home network is allowed.

No new equipment in the corporate

There should be no need to have any new additional equipment such as Home Agents in the virtual home network. It shall also be possible for an ISP to offer Mobile IP as a service to corporate without placing any equipment at the customers premises.

Roaming on Internet

Users shall be able to freely roam on Internet, hot spots, working from home or connected via WWAN such as UMTS or GPRS.

Roaming within the intranet

Users shall be able to freely roam within the intranet as well.

However, some unoptimal traffic flows could be accepted in this case, such as traffic sent via the central HA in case of outside the virtual home network.

Relies on normal router operation

All changes to network equipment shall be possible to perform on existing router equipment and shouldn't involve features only found in future or very recent operating systems/routers.

Handover in reasonable times

The handover times shall be reasonable (˜1 sec). However, the handover case when going away to home may not be fast enough to e.g. handle uninterrupted real-time services.

Possibility to have the HA in another administrative domain

The HA shall be able to be placed in another administrative domain.

It's acceptable to leverage existing VPN techniques such as virtual routing.

Compatible with AAA

The solution shall be compatible with existing AAA roaming techniques on Internet and also be deployable together with enterprise AAA in enterprise deployment.

Maintained security

The security level for normal VPN services shall be leveraged and not compromised.

Reasonable traffic flows

The traffic patterns within the corporate shall be reasonable. It is for example not acceptable to have normal traffic tromboned to a HA when located in the home network. Also, existing network divisions in distribution networks and access networks shall be maintained.

Solution

With the purpose of providing a solution according to the above-mentioned requirements the present invention proposes an inventive Routed Home Network that allows a Mobile Client to be at home at a LAN segment that is not directly attached to its Home Agent. The invention adds mechanisms for the client to detect when it is in the mobile home network and how the Mobile Client deregisters in the mobile home network.

Further it describes the mechanisms for the Home Agent to detect when the Mobile Node registers away, and how the Home Agent acts in order to absorb traffic to the Mobile Client for which it acts as a proxy.

The present invention teaches that each Mobile Client is given a public IP address that does not coincide with the addresses in the routing domain. The Mobile Client addresses are aggregated so that no addresses need a host route to be routable.

Each address aggregate is allocated to a LAN segment in the existing routing domain. The default gateway attached to the segment is configured to advertise the address aggregate as a static route through the Internal Gateway Protocol (IGP). In this specific case the IGP is OSPF, but the invention is not limited to OSPF as the IGP.

Mobile Clients with home-addresses belonging to the aggregate will consider the segment as its virtual home link, and operate in Mobile-IP deregistered mode while attached to the segment. The segment is called the Mobile Home Network. Note that the home-address of the Mobile Client is one of the addresses in the address aggregate. The advertisement of the static route makes the addresses routable in the routing domain.

When the Mobile Client attaches to a link in the routing domain, which is not its Mobile Home Network, it will register away in Mobile IP sense. The Home Agent then advertises a host route for the Mobile Client into the routing domain so that packets for the Mobile Client are routed to the Home Agent. The Home Agent then tunnels the packets to the Mobile Clients current location.

When the Mobile Client returns back to its virtual home link, the client will, as usual, try to obtain a DHCP address. However, in the DHCP response a special option will tell the Mobile Node that it is in fact in its home network and that it should deregister. The Mobile Client then sends a deregistration message to the Home Agent. When the Mobile Client receives a successful deregistration reply, the Mobile Client resumes normal operation, using the home address of the static aggregate.

The Home Agent, will on successful deregistration withdraw the host route. Packets for the Mobile Client are then routed based on the static aggregate route.

The present invention allows a Mobile Client to be at home at a LAN segment that is not directly attached to its Home Agent requiring no awareness by the Mobile IP protocol in any device on the intranet except the Home Agent.

An inventive method for decoupling a Mobile IP home network from its Mobile IP Home Agent with support for roaming on the intranet as well as the internet teaches that the normal operation of the IGP is assumed, and that a static route for a Mobile Address aggregate is used to distribute Mobile IP addresses in the IGP.

The invention teaches that there might be VPN devices located between the Mobile IP Home Agent and Mobile Client.

The security level for normal VPN services is leveraged and not compromised when the VPN terminator is located in different network device than the Mobile IP Home Agent.

An advantage of the invention is that it provides a solution without unreasonable traffic patterns, such as always tromboning Mobile client traffic through the HA.

Another advantage is that there are no tunnels used between the Home agent and the home network.

The invention may be implemented without changes in the network devices functionality or configuration needed other than in the Mobile IP Home agent and Mobile Client. The normal operation of the IGP is assumed and no Mobile IP functionality at all is needed in network devices attached to the Mobile Home Network.

One embodiment of the invention teaches that the IGP is used for directing traffic to the HA for Mobile Clients that are roaming outside their Mobile Home Network.

Another embodiment teaches that the proxy ARP function of the default gateway is used for directing traffic in the Mobile Home Network to the HA for the Mobile Clients that are roaming outside their Mobile Home Network.

Yet another embodiment teaches that the Mobile IP registrations are redistributed to the IGP in order to direct traffic to the HA for the Mobile clients that are roaming outside their Mobile Home Network, in which case the traffic is directed toward the HA instead of the Mobile Address aggregate using host routes.

Yet another embodiment teaches that the Mobile IP registrations are redistributed to the IGP in order to direct traffic to the HA.

The inventive method shows that the Mobile Client deregisters over several IP router hops to the Mobile IP Home Agent, where the Mobile Home Agent verifies that the Mobile Client is located in the Mobile Home Network by the source address of the Mobile IP registration request, or where the Mobile Client detects that it is in the Mobile Home Network by using DHCP options.

### BRIEF DESCRIPTION OF DRAWINGS

The foregoing, and other objects, features, and advantages of the invention will be apparent from the following description of preferred example embodiments as well as illustrated in the accompanying drawings in which reference characters refer to the same parts throughout, where:

FIG. 1 is a simplified schematic illustration of the set up of a router in a home network according to the present invention,

FIG. 2 is a simplified schematic illustration of a MN in its home network,

FIG. 3 is a simplified schematic illustration of a MN moving to another network,

FIG. 4 is a simplified schematic illustration of a HA that is placed centrally within the administration of the ISP, and

FIG. 5 is a simplified schematic illustration of a MN roaming in the intranet.

### DETAILED DESCRIPTION OF EMBODIMENTS AS PRESENTLY PREFERRED

In the following description, for the purposes of explanation and not limitation, specific details are set forth, such as particular embodiments, circuits, signal formats, techniques, etc. in order to provide a thorough understanding of the present invention. Although specific protocols are referred to for the purpose of facilitating the description, the present invention is not necessarily limited to such specific protocols. However, it will be apparent to one skilled in the art that the present invention may be practiced in other embodiments that depart from these specific details. In other instances, detail description of well-known methods, devices, and circuits are omitted so as not to obscure the description of the present invention under unnecessary detail.

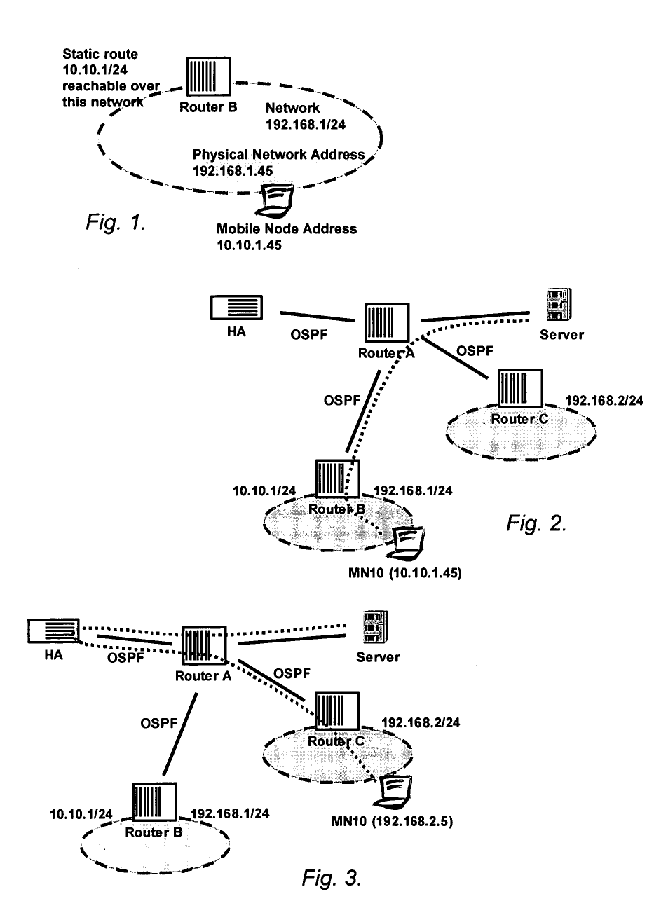

The present invention will now be described through several exemplifying embodiments. With reference to FIG. 1 it is shown that a static route is added to the home network interface to define that the mobile nodes (MN) are reachable over this interface through their mobile node addresses. The route to the home network is propagated using the routing protocol (IGP) so that the entire intranet knows that the MN nodes are reached at their home network over this interface. The MN's sends and receives traffic using their mobile node address.

The technique to have a static route pointing to a network instead of having an alias configured on the physical interface is common even in prior art in order to avoid a lot of ICMP redirections. The practice is e.g. recommended in Cisco CCIE literature.

In FIG. 1 router B will advertise the 192.168.1/24 into the routing domain. In addition, router B will be configured with the static route 10.10.1.0/24 and therefore advertise that route towards the cloud.

cisco# ip route 10.10.1.0 255.255.255.0 192.168.1.1

Note that the gateway for the static routes is set to the routers own IP address. The router will then ARP for any address in the 10.10.1.0/24 range, which is necessary, since the Mobile Client will be attached to its home segment, and indeed to any segment in the concerned network configuration, with a topologically doubtful address.

The Home Agent HA does not have an ordinary home network defined for these mobile nodes. It's simply defined as “mobile” and refers to the fact that the address range is not allocated on an interface defined on this Home Agent. The configuration of the mobile home networks specifies over what interface it can be reached, which address range that is defined and what next hop gateway are used to reach this mobile home network.

When the MN arrives or is started up in its virtual home network it will, as usual, try to obtain a DHCP address. However, in the DHCP response the Mobile Home Network Name option will tell the Mobile Node that it is in fact in its home network and that it should deregister. The MN then sends a deregistration message to the HA.

The home agent first authenticates the deregistration message with the MN-HA secret, then verifies that the Registration Request came on the correct interface. If they match the information of the virtual home network for that particular MN then the HA responds to the deregistration message (registration reply (RRP) with a lifetime of zero). The MN will then start using its MN home address, not its (co-located) physical home address. The MN must answer ARP's over this home network for its MN home address.

When the MN moves to another network on the intranet, or to the Internet it will register another Care-of-Address (COA) with the HA. The HA will accept the registration and create a mobility binding. The HA then inserts a host route in the IGP that this specific MN IP address is reached via the HA. The host route propagates through the network and will get precedence over the advertised home network route since it's more specialized. When the MN arrives home again it will get deregistered and the HA will revoke the host route.

There might be foreign agent in some parts of the network. When roaming into network with an FA the MN registers with a COA just as before.

### EXAMPLE

Mobile node MN10 is allocated a static home address 10.10.1.45. Its physical home network is 192.168.1/24. Its mobile home network is 10.10.1/24 which is installed with a static route on the network interface of the local router B. All routers in the intranet and the HA runs OSPF. The HA does not advertise its home network addresses to OSPF.

Deregistered at Home

FIG. 2 shows that when MN10 is turned on in the morning it hears no advertisements or get any response on its solicitations. The MN obtains an address via DHCP, the MN gets 192.168.1.5 and also notices that it is in fact at home through the Mobile Home Network Name DHCP option. It deregisters with its HA and gets a RRP with a de-registration so it assumes to actually be home and resumes normal home operation using its mobile node home address as its source address for traffic.

When the server sends a good morning packet to the MN, router A has a OSPF route to 10.10.1/24 network via router B. Router B has a static route to the 10.10.1/24 network via interface 1. And the MN picks up the packet.

Registered Away Co-Located

FIG. 3 shows that when the MN moves to another network on the intranet, or to the Internet, it will notice a move. The MN obtains an address via DHCP and gets 192.168.2.5. The MN will not get any Mobile Home Network Name option or if it gets it then it's not with the correct name. It registers with its HA using 192.168.2.5 as the Co-located Care-of-Addres (CCOA). The HA will notice that the MN is away from its home network, and will register him as being registered away with COA set to 192.168.2.5. The HA then inserts a host route that 10.10.1.45/32 is reachable over its interface to OSPF. The host route propagates through the network and will get precedence over the advertised home network route on router B since it's more specialized.

The server sends a good afternoon packet to the MN, router A has an OSPF route to 10.10.1.45/32 network via HA. The HA has a 10.10.1.45 registered with a COA 192.168.2.5 so it tunnels the packet to there. Router A has an OSPF route to the 192.168.2/24 via router C. Router C is directly attached to Mobile Node COA. And the MN picks up the packet and de-tunnels it.

Mobile IP Considerations

The implementation of an inventive method does not change or amend the Mobile IP protocol as defined in “IP Mobility Support for IPv4, RFC3220”. However, some behavior descriptions need to be defined and clarified. There are no new messages or extensions needed.

MN Considerations

The Mobile Node MUST check the DHCP messages for the Mobile Home Network Name option. If the Mobile Home Network Name option matches the name of the home network for the Mobile Node, the mobile node MUST deregister with the HA.

The mobile node MUST use the obtained IP address obtained over DHCP as the source IP address and the co-located care-of address in the de-registration.

The mobile node, when receiving the lifetime zero in a successful registration reply, MUST consider itself deregistered and in it's home network. The mobile node MUST then resume normal home operation as described in “IP Mobility Support for IPv4, RFC3220” regarding ARP, proxy-ARP and gratuitous ARP. The mobile node SHOULD NOT reregister with it's home agent periodically.

The mobile node SHOULD deregister with the HA even if it has no outstanding registration in order to remove any ambiguity about where the MN home address is reachable. The MN SHOULD NOT resume normal home operation until an authenticated deregistration reply is received in order to for certain know that it is at home. This is to avoid possible HA fraud.

If the mobile node is not configured with a home address, it MAY use the Mobile Node NAI extension to identify itself, and set the Home Address field of the Registration Request to 0.0.0.0. In this case, the mobile node MUST be able to assign its home address after extracting this information from the Registration Reply from the home agent.

HA Considerations

A home agent MUST maintain a binding between MN's identified either by NAI or MN home address and corresponding physical home networks. This is called a home network binding.

A home agent MUST accept Deregistration Requests for mobile nodes that there is a valid MN-HA security association and for which the source and the co-located care-of address are matching. The lifetime in such a registration reply SHOULD be set to zero.

If the home agent receives a Registration Request with non-matching source IP address and co-located care-of address which contains a lifetime of zero, the home agent SHALL NOT respond with a successful Registration Reply.

A home agent SHALL NOT have any physical network for the mobile nodes in the home network binding table. The home agent SHALL NOT issue any ARP, proxy-ARP and gratuitous ARP. As described in “IP Mobility Support for IPv4, RFC3220” for the mobility bindings that have networks in the home network bindings table. A home agent MAY optionally also has a physical network for which it is performing normal home agent operation for some subset of mobile nodes. This is however outside the scope of the present invention.

When a Home Agent gets a new mobility binding the home agent MUST insert a host route corresponding to the MN home address into the routing domain. The home agent MUST maintain that such a host route is distributed in the routing domain.

A home agent MUST revoke the host route corresponding to the MN home address into the domain for any cancelled mobility binding that have networks in the home network bindings table.

Handling Multiple Domains

In this case the HA is placed centrally within the administration of the ISP. This HA is part of several different domains, one for each connected corporate. One domain is most likely also defined as one address space. The actual addresses defined on the different interfaces have to be different but are part of the address space of the domain on that interface.

The central HA is connected with direct connections to the different corporate. This is most probably not a direct PHY but rather a VLAN and Virtual Leased Line service but that's beyond the scope of the invention. This centrally places home agent has one instance of a virtual router for each of the attached domains. There are an instance of IGP running on each virtual router, participating in the routing domain of that corporate.

Forwarding

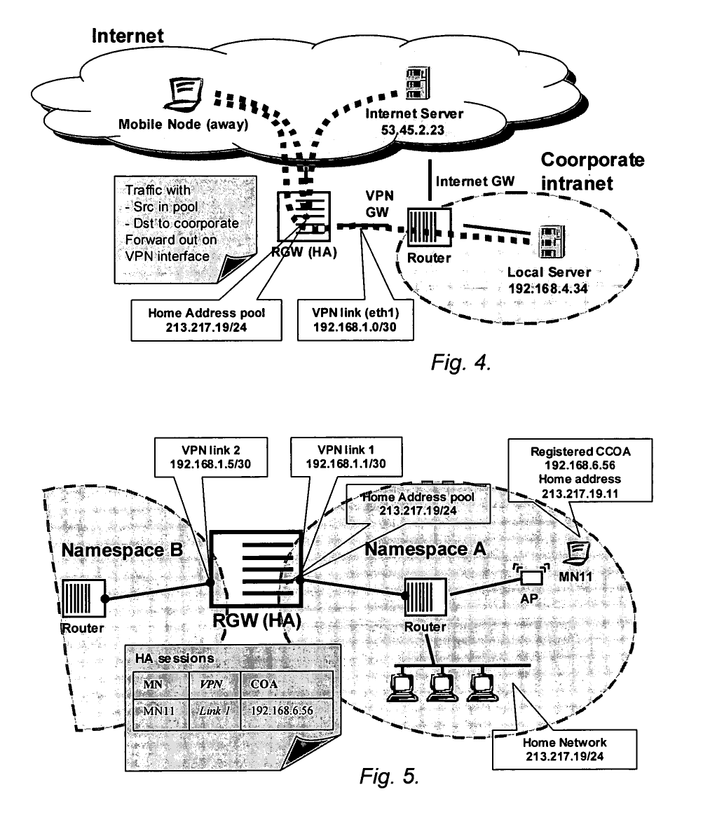

Normally VPN forwarding requires virtual routing, i.e. separate routing and forwarding entities per corporate. As can be seen in FIG. 4, this is however out of the question for the HA. However there is a firewall function ( the “to” keyword), which could be used to circumvent normal routing. The rule could e.g. look like

# pass in quick on enc0 to eth1:192.168.1.2 from 213.217.19/24 to 192.168/16

The traffic from the roaming corporate users to the corporate intranet, i.e. matching “from 213.217.19/24 to 192.168/16”, are put out directly on the VLAN/VPN link to the corporate router. Other traffic is routed as usual. Other corporate home networks have similar entries in the centrally placed HA, which match their home address pool.

Routing

Routed home network builds on the assumption that the HA issues a route in the intranet to point to the HA from that specific roaming host address. In this way, the traffic normally routed to the home network gets instead routed to the HA.

One solution is of course to let the HA issue a route into the routing domain with an EGP (i.e. BGP4). This solution however has some alarming side effects, the most obvious is that it requires each corporate to deploy not only intranet routing but also to have BGP4 running on the corporate edge router and participate in the worldwide routing. This is not acceptable.

Another approach is to let each interface be part of the intranet address space and have virtual routing processes on each interface, each participating in the respective routing domain. There must be no NAT or similar on the interface or link. This is the preferred approach.

It is however a greatly reduced OSPF that are being used, more of an route injector than an OSPF routing daemon. This is possible since the link always are going to be deployed as a stub link, and that there is no relation between the Link-State Advertisement (LSA) database and the routing table in the HA. All routing decisions are made based on the static mapping of source addresses and interfaces. So, if a mobile node registers with the HA, then a LSA with that route is injected in the routing domain, if a mobile node is deregistered, a LSA removing that route is injected.

MN's Going Home

The hardest problem for the client is to know when it is in its home network. Several different ways exist. Since the client most probably is going to move between address spaces a few proposals are not strong enough

Use the Mobile IP home agent option in DHCP.

Since there most probably are several different employees of one corporate, which share the same HA, this is not enough to uniquely identify a home network.

Use the default router in DHCP or the router in router advertisements.

Since it's impossible to differentiate one private address network from another, i.e. there are lots of 192.168.4.1 gateways, and only one is home.

The conclusion is that a Network Access Identifier (NAI) for the home network needs to be defined in order to identify it.

DHCP Considerations

The DHCP option number space (1-254) is split into two parts. The site-specific options (128-254) are defined as “Private Use” and are not under IETF control. The public options (1-127) are defined as “Specification Required” and new options must be reviewed by the DHC Working Group prior to assignment of an option number by IANA.

Most DHCP servers, e.g. the Windows and ISC doesn't respond with any options unless asked for in the DHCP discover message. Windows 2000 and Windows XP have no longer the option to define what options to request in the registry like Windows NT. Since the invention relies on that Windows obtains all the required options, the invention utilizes the options normally requested by Windows. These include option 43 “Vendor Specific Information”.

Ideally, a client requesting proprietary information should use the DHCP class identifier option (code 60) to specify what information it needs. This is then, in most DHCP servers, mapped to what gets sent in the vendor specific information option (code 43). But there is no mechanism to define the content of option 60 on Windows machines. This is instead used to identify different Windows version, e.g. “MSFT 5.0” is send in option 60 on Windows 200 machines.

Since there are no mechanism known to change the content of option 60 in the Windows DHCP discover, the invention assumes that the Vendor-specific information must only be used to distribute the Mobile Home Network Name option.

Hence, the definition for option 43 Vendor-specific information in mobile home networks is:

Vendor-specific information option

In the case with Mobile Home Networks, this option specifies the name of this particular mobile home network. The name is formatted as a character string containing UTF-8 encoded 10646 as defined in UTF-8, a transformation format of ISO 10646, RFC 2279.

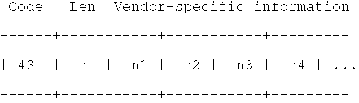

This value MUST be configurable for each mobile home network. The name MUST be unique. It may for example contain the enterprise name and a location identifier. Example “ACME_Inc, Stockholm_HQ,Division_WISP,

Deregistering

When the Mobile Node has discovered that it is in its home network, it MUST issue a de-registration (Registration Request (RRQ) with lifetime zero) to the HA to indicate that it is home. It MUST NOT resume any kind of home network behaviour, specifically not to issue any gratuitous ARPs, until the RRP has arrived confirming the de-registration.

MN's Roaming in the Intranet

It's also quite possible that the mobile node will roam around on the intranet or in another intranet. In this case, the roaming Mobile Node will be registered away. If there are no FA's there, it will register with collocated care-of-address.

However, there are a big problem for the HA to resolve the COA, since it's most probably located in a private address space. It's not only possible to send traffic to the mobile node using normal routing since there are no connection between the HA's central routing table and the individual addresses in the corporate. Also, the address spaces are overlapping.

The solution is shown with reference to FIG. 5, where the HA in it's home session table not only have to keep track of the COA, but also which interface the registration came in on. Normal routing has to be circumvented and traffic to the mobile node has to be placed directly on the interface, with destination MAC address set to the corporate gateway and the destination IP set to the COA.

The HA must in the session table have information on what interface and gateway MAC address the registration request came in on. This data is then used for all communication related to this session. This is valid both for signalling traffic originating in the HA itself, as with encapsulated tunnel traffic send to the MN. A similar mechanism is used in the FA case, but this mechanism has to be amended in the HA case.

Also note the special case that even though each interface is part of the namespace defined for the corporate, the addresses defined for the interfaces must be unique for this specific HA.

Security

The security implications are minor. A MN always deregisters and have to do a mutual authentication in order to start sending traffic in clear. This is the case according to prior art, and is still the case. A possible attack is to make the home network NAI to be the same as a known network, and then sniff when MN's roam in and turn off their traffic.

However, there should be tests in the HA that makes sure that the de-registration request comes in over the correct interface.

Move Detection

There are two algorithms described for move detection in Mobile IP, which both depend on the presence of Agent Advertisements on the segment where the Mobile Client is attached. In the RHN case, there is no Mobility Agent present, so the Mobile Client will hear no Agent Advertisements. However, there should at least be a router, acting as default router on the segment. By using the presence of the default router as an indication that the Mobile Client has indeed attached to the segment in question, the problem of move detection becomes the problem of detecting whether a packet sent by the Mobile Client will be forwarded by the router. In [RFC816] some possible approaches are discussed:

The Mobile Client may continuously poll the router; [RFC816] suggests that the host solicits a response by an ICMP Echo Request.

However, an ARP request may be a better choice

The Mobile Client may poll the router, but only when some indication that higher levels complains that the service is defective. For example, a TCP segment resend might qualify as such an indication.

If the router has IRDP active (which is default on Cisco), the router will send Router Advertisements each 7 to 10 minutes.

The first proposal above does not scale very well, and the second proposal is probably out of question on a Windows machine. The best approach is to require that IRDP is active, with a frequency that is much higher than one Router Advertisement each 450-600 second (Cisco default). For example:

cisco# ip irdp maxadvertinterval 6

cisco# ip irdp minadvertinterval 4

When the Mobile Client requests an IP address from DHCP on a segment without a Mobility Agent, it requests the Router DHCP Option to be delivered. The most preferred router in the Router Option router list is then the router from which the Mobile Client shall listen for Router Advertisements (the Mobile Client will immediately solicit for a Router Advertisement to find out the hold time). If then the Mobile Client does not hear from the default router in one hold time (defaults to 3 * maxadvertinterval) seconds, it will recognize that it has moved. This can be extended with the following procedure: if the Mobile Client hears a Router Advertisement from a previously unheard-of router, it may immediately conclude that it has moved.

It will be understood that the invention is not restricted to the aforedescribed and illustrated exemplifying embodiment thereof and that modifications can be made within the scope of the inventive concept as illustrated in the accompanying claims.

1. A method for decoupling a Mobile IP home network from its Mobile IP Home Agent with support for roaming on the intranet as well as the Internet, characterized in that the normal operation of the IGP is assumed, and that a static route for a Mobile Address aggregate is used to distribute Mobile IP addresses in the IGP.

2. A method according to claim 1, characterized in that the IGP is used for directing traffic to the HA for Mobile Clients that are roaming outside their Mobile Home Network.

3. A method according to claim 1, characterized in that the proxy ARP function of the default gateway is used for directing traffic in the Mobile Home Network to the HA for the Mobile Clients that are roaming outside their Mobile Home Network.

4. A method according to claim 1, characterized in that the Mobile IP registrations are redistributed to the IGP in order to direct traffic to the HA for the Mobile Clients that are roaming outside their Mobile Home Network.

5. A method according to claim 4, characterized in that the traffic is directed toward the HA instead of the Mobile Address aggregate using host routes.

6. A method according to claim 1, characterized in that the Mobile IP registrations are redistributed to the IGP in order to direct traffic to the HA.

7. A method according to claim 1, characterized in that the Mobile Client deregisters over several IP router hops to the Mobile IP Home Agent

8. A method according to claim 7, characterized in that the Mobile Home Agent verifies that the Client is located in the Mobile Home Network by the source address of the Mobile IP registration request.

9. A method according to claim 7, characterized in that the Mobile client detects that it is in the Mobile Home Network by using DHCP options and IRDP Router Advertisements.

10. A method according to claim 1, characterized in that the Home Agent utilizes an IGP route injector and MAC layer redirect per physical interface for shared deployment scenarios where an address overlap between the physical networks hosting the virtual home networks may exist.

11. A method according to claim 10, characterized in that the Home Agent in it's home session table keep track of the interface and gateway MAC address over which the registration form the Mobile Node came in order to allow for overlapping care-of-addresses at visited networks.
